(19) United States
(12) Patent Application Publication
(10) Pub. No.: US 2011/0186726 A1
(43) Pub. Date: Aug. 4, 2011

(54) SAMPLE CONTROL FOR IMPROVED SENSITIVITY AND CLEAR DOWN TIMES FOR A MEMBRANE BASED IMS

(75) Inventor: Frank Joseph Kuja, Laval (CA)

(73) Assignee: Smiths Detection Montreal Inc.

(21) Appl. No.: 12/997,355

(22) PCT Filed: Jun. 10, 2009
(86) PCT No.: PCT/IB2009/006269

§ 371 Date: Feb. 28, 2011

Related U.S. Application Data
(60) Provisional application No. 61/129,245, filed on Jun. 13, 2008.

(51) Int. Cl. H01J 49/34; H01J 49/00

(52) U.S. Cl. 250/282; 250/288; 250/287

(57) ABSTRACT

An analytical instrument that includes a chemical substance analyzer. The chemical substance analyzer includes a desorber, a swab receptacle forming a chemical substance entrainment area proximate the desorber, a conduit in fluid communication with the entrainment area, and a membrane, wherein the membrane extends across a cross-section of the conduit, wherein the membrane is positioned to have a desorber side in gas communication with the desorber and an analysis side opposite the desorber side. A the first volumetric flow rate is less than a specified amount per a cross-sectional conduit area.

### CROSS-REFERENCE TO RELATED APPLICATIONS

This application claims priority to U.S. Patent Application No. 61/129,245, filed Jun. 13, 2008, the entire contents of which is hereby incorporated by reference in its entirety.

### BACKGROUND

Some embodiments of the present invention are applicable to the field of analytical instruments for detecting chemical substances, including explosive substances and narcotic substances.

### SUMMARY

Some embodiments of the present invention include an apparatus for and method of performing an analysis of a chemical substance, including an analysis utilizing ion mobility spectrometry; the apparatus/method including parameters which enhance an amount of the chemical substance available for analysis, thus improving the macroscopic sensitivity of the analysis. Applicants surprisingly discovered that this improved macroscopic sensitivity may be achieved by reducing a flow of gas from a sample containment area (e.g., a swab receptacle) to a membrane of an analytical instrument (for example, an ion mobility spectrometer (IMS)), the gas entraining the chemical substance (having been released from, for example, the swab) for transfer to the membrane. It has been learned that by limiting the volumetric flow of gas, additional amounts of the sample chemical substance accumulate on the membrane/interacts with the membrane. This increased concentration, in turn, increases the macroscopic sensitivity of the analysis by allowing additional sample chemical to pass through the membrane for analysis, because more sample is transferred to the membrane. This is surprising, because in typical IMS systems, relatively large amounts of air flow through the sampling substrate (e.g., the swab) is believed to increase the amount of sample that reaches the analysis side of the membrane, and thus improve sensitivity. Thus, some embodiments of the present invention may operate in a manner contrary to conventional wisdom, achieving previously unexpected results.

Along these lines, in an exemplary embodiment of the present invention, there is an analytical instrument, comprising, a chemical substance analyzer, including: a desorber; a swab receptacle forming a chemical substance entrainment area proximate the desorber; a conduit in fluid communication with the entrainment area; and a membrane, wherein the membrane extends across a cross-section of the conduit, wherein the membrane is positioned to have a desorber side in gas communication with the desorber and an analysis side opposite the desorber side; wherein the analytical instrument is adapted to supply a gas at a first volumetric flow rate through the entrainment area to entrain in the gas at least a portion of a chemical substance located in the entrainment area and direct the gas entraining the chemical substance through a conduit that guides the gas entraining the chemical from the entrainment area towards the membrane so that at least a portion of the entrained chemical substance interacts with the desorber side of the membrane, wherein the membrane is adapted to diffuse at least a portion of the chemical substance that has been transferred to the membrane by interaction on the desorber side of the membrane through the membrane to the analysis side, and wherein the first volumetric flow rate is less than about 50 cubic centimeters per minute per 3 cubic centimeters of cross-sectional conduit area.

### BRIEF DESCRIPTION OF THE DRAWINGS

FIG. 1 is a schematic of an analytical instrument according to an exemplary embodiment of the present invention.

FIG. 2 presents an exploded view of certain components schematically depicted in FIG. 1.

FIG. 3 presents a cross-sectional view of a component of an exemplary embodiment of the present invention.

FIG. 4 presents another cross-sectional view of a component of an exemplary embodiment of the present invention.

FIG. 5 presents yet another cross-sectional view of a component of an exemplary embodiment of the present invention.

### DETAILED DESCRIPTION OF SOME EMBODIMENTS

Some embodiments of the present invention include a method of and an apparatus for performing ion mobility spectrometry with excellent sensitivity. The method involves adjusting a flow of gas that impinges on a membrane to a relatively low volumetric flow rate. More specifically, the flow of gas impinging on the membrane is of a quantified limited volumetric amount, at least during a time period when the sample is being transferred to the membrane (during “sample loading”). By limiting the volumetric flow of gas during sample loading, the amount of sample that can be collected on the membrane can be increased, which in turn increases the amount of material that may diffuse through the membrane, and thus be used, by, for example, an ion mobility spectrometer of the analytical instrument (i.e., increasing the amount of sample subjected to IMS) thus increasing the macroscopic sensitivity of the instrument/testing method. It is noted that in some embodiments of the present invention, the volumetric flow of gas impinging on the membrane may be increased after sample has been subjected to analysis, to remove any remaining sample and decreases the chances of a false positive or a false negative caused by contaminants masking the presence of the sample of interest.

Reducing the flow of gas past the membrane runs counter to the operation of typical analytical instruments utilized for detecting sample chemicals, at least for analytical instruments which rely on IMS. As noted above, traditional IMS detectors utilize relatively high volumetric flow rates of gas flow through the sample substrate (the swab) to increase the amount of sample substance that reaches and is impinged upon the membrane. The volumetric flow rates disclosed herein are not high, and, in comparison to typical volumetric flow rates of concomitant machines, are relatively low.

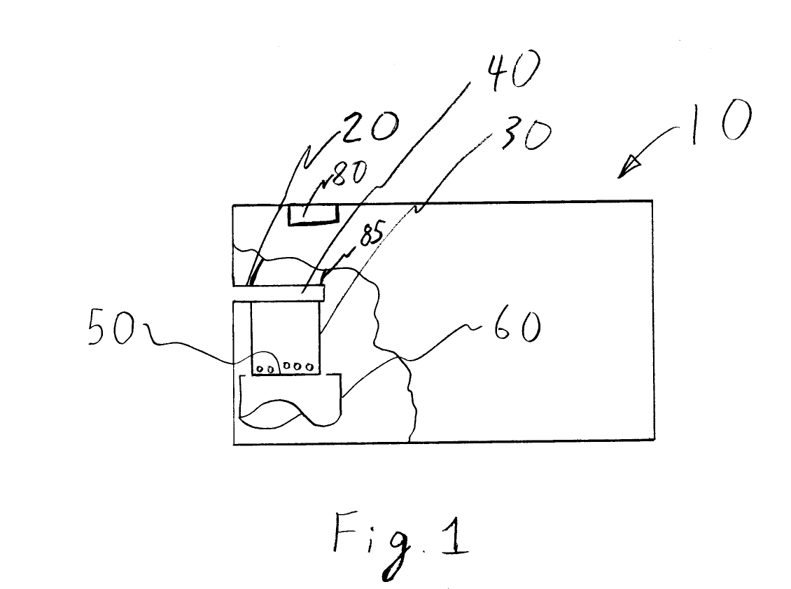

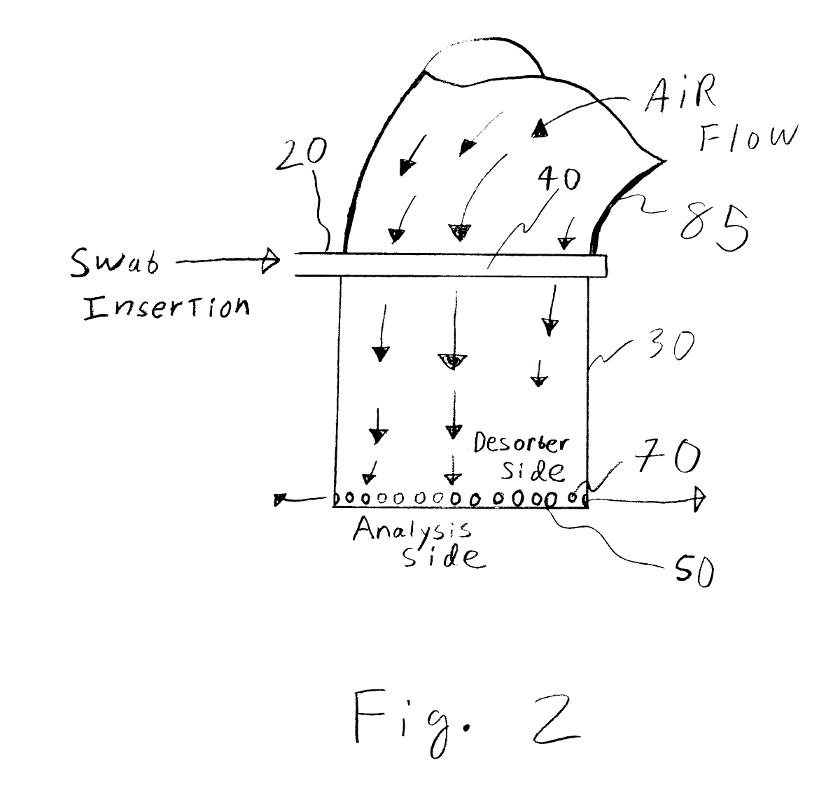

Referring now to FIGS. 1 and 2, in a first embodiment of the present invention, there is an analytical instrument 10 which includes a chemical substance analyzer. In the embodiment depicted in FIG. 1, the analytical instrument 10 is a device that is configured to accept a swab that has been placed into contact with an article believed to have been exposed to a chemical substance of interest, including explosives and/or narcotics. In this regard, the analytical instrument 10 includes a swab receptacle 20 configured to receive the swab. The swab receptacle 20 is proximate to a desorber (conceptually identified as element 40), and is in fluid communication with a gas conduit 30. Conduit 30 leads to a membrane 50, which is positioned proximate an IMS drift tube 60. As may be seen in FIG. 2, the gas conduit 30 includes exhaust ports 70 at one end of the conduit 30, just above the membrane 50. The membrane 50 spans the entire diameter of the conduit 30, although in other embodiments, this may not be the case. The membrane 50 has a desorber side and an analysis side, the analysis side “facing” the IMS tube 60, the desorber side “facing,” the conduit 30 (more particularly, the desorber side faces a stream of air flowing from the desorber—more on this below). A pump 80 is positioned upstream of the receptacle 20, and directs gas to flow to the receptacle 20 through conduit 85, although in other embodiments, a “negative pressure” may be created by exposing the exhaust ports 70 to a vacuum, thus pulling gas through the conduit 30 as opposed to pushing the gas through the conduit 30.

In operation, a swab is placed into the receptacle 20. Gas flows down conduit 85, through the swab and then down conduit 30, where the gas impinges upon membrane 50. In this regard, the receptacle 20 serves as an entrainment area. The gas then exists conduit 30 though exhaust ports 70.

In some embodiments, the gas passing through the swab, located in receptacle 20, entrains a chemical substance brought into the receptacle on the swab. In some embodiments, a desorber 40 is used to enhance the amount of chemical substance that is available for entrainment into the gas as the gas passes through the swab. Having been entrained in the gas, the chemical substance is carried with the gas down conduit 30, where it impinges on the membrane 50, along with the gas. At least some of the entrained chemical substances in the gas flow is transferred to the membrane 50, via interaction with the desorber side, thus the membrane collects some of the chemical substance.

In practice, at least some of the chemical substance that interacts with the desorber side of the membrane 50 passes through the membrane 50, via diffusion, to the analysis side of the membrane (the side facing the IMS flow tube 60, where the actual analysis of the chemical substance occurs), for exposure and entry into the IMS tube 60. More specifically, some of the chemical substance that has been transferred to the membrane through interaction on the desorber side of the membrane 50 will migrate (diffuse) through the membrane 50 to the analysis side of the membrane 50. At least some of the transferred chemical substance so migrates through the membrane 50, such that it may be analyzed on the analysis side by an analytical device, such as for example, by an ion mobility spectrometer.

According to an exemplary embodiment of the present invention, the volumetric gas flow rate through the conduit 30 amounts to, in some embodiments, less than about 50 cubic centimeters per minute per 3 cubic centimeters of cross-sectional conduit area. According to another exemplary embodiment of the present invention, volumetric gas flow rate through the conduit 30 amounts to less than about 30 cubic centimeters per minute per 3 cubic centimeters of cross-sectional conduit area. According to another exemplary embodiment of the present invention, volumetric gas flow rate through the conduit 30 amounts to less than about 20 cubic centimeters per minute per 3 cubic centimeters of cross-sectional conduit area. According to another exemplary embodiment of the present invention, volumetric gas flow rate through the conduit 30 amounts to less than about 10 cubic centimeters per minute per 3 cubic centimeters of cross-sectional conduit area. According to another exemplary embodiment of the present invention, volumetric gas flow rate through the conduit 30 amounts to less than about 8 cubic centimeters per minute per 3 cubic centimeters of cross-sectional conduit area. According to another exemplary embodiment of the present invention, volumetric gas flow rate through the conduit 30 amounts to less than about 6 cubic centimeters per minute per 3 cubic centimeters of cross-sectional conduit area. According to another exemplary embodiment of the present invention, volumetric gas flow rate through the conduit 30 amounts to less than about 4 cubic centimeters per minute per 3 cubic centimeters of cross-sectional conduit area. According to another exemplary embodiment of the present invention, volumetric gas flow rate through the conduit 30 amounts to less than about 2 cubic centimeters per minute per 3 cubic centimeters of cross-sectional conduit area. According to another exemplary embodiment of the present invention, volumetric gas flow rate through the conduit 30 amounts to about 1-2 cubic centimeter per minute per 3 cubic centimeters of cross-sectional conduit area. According to another exemplary embodiment of the present invention, volumetric gas flow rate through the conduit 30 amounts to about 1-5 cubic centimeters per minute per 3 cubic centimeters of cross-sectional conduit area.

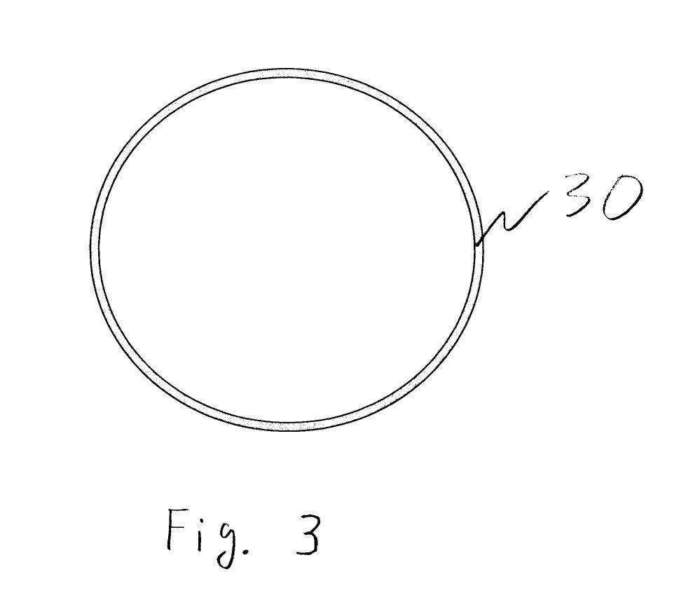

The phrase “cross-sectional conduit area” will now be explained. In regard to the present invention, the area of a cross-section of the interior of conduit 30 facing the swab receptacle, at the receptacle end of conduit 30, is defined as the “cross-sectional conduit area,” as there is believed to be a relationship between the cross-sectional area of the conduit 30 to the amount of chemical substance that is entrained in the gas. FIG. 3 depicts a cross-section of the conduit 30 at this location, the area inside the conduit walls being the cross-sectional conduit area.

By way of example only and not by way of limitation, if the interior of the conduit 30, at the end of the conduit 30 facing the receptacle 20, had a cross-sectional area of 3 square centimeters, the cross-sectional conduit area would be 3 square centimeters.

According to another exemplary embodiment of the present invention, the volumetric gas flow rate through the conduit 30 amounts to, in some embodiments, less than about 50 cubic centimeters per minute per 3 cubic centimeters of working membrane area. According to another exemplary embodiment of the present invention, volumetric gas flow rate through the conduit 30 amounts to less than about 30 cubic centimeters per minute per 3 cubic centimeters of working membrane area. According to another exemplary embodiment of the present invention, volumetric gas flow rate through the conduit 30 amounts to less than about 20 cubic centimeters per minute per 3 cubic centimeters of working membrane area. According to another exemplary embodiment of the present invention, volumetric gas flow rate through the conduit 30 amounts to is less than about 10 cubic centimeters per minute per 3 cubic centimeters of working membrane area. According to another exemplary embodiment of the present invention, volumetric gas flow rate through the conduit 30 amounts to less than about 8 cubic centimeters per minute per 3 cubic centimeters of working membrane area. According to another exemplary embodiment of the present invention, volumetric gas flow rate through the conduit 30 amounts to less than about 6 cubic centimeters per minute per 3 cubic centimeters of working membrane area. According to another exemplary embodiment of the present invention, volumetric gas flow rate through the conduit 30 amounts to less than about 4 cubic centimeters per minute per 3 cubic centimeters of working membrane area. According to another exemplary embodiment of the present invention, volumetric gas flow rate through the conduit 30 amounts to less than about 2 cubic centimeters per minute per 3 cubic centimeters of working membrane area. According to another exemplary embodiment of the present invention, volumetric gas flow rate through the conduit 30 amounts to about 1-2 cubic centimeter per minute per 3 cubic centimeters of working membrane area. According to another exemplary embodiment of the present invention, volumetric gas flow rate through the conduit 30 amounts to about 1-5 cubic centimeters per minute per 3 cubic centimeters of working membrane area.

The phrase “working membrane area” will now be explained. In regard to some embodiments of the present invention, the area of the membrane 50 on the conduit side/desorber side that is utilized to capture some or all of the chemical substance from the gas for diffusion across the membrane 50, to the analysis side, is of interest. During an analysis, typically only the chemical substance that has been diffused through the membrane is subject to an analysis (e.g. using IMS, etc.). Accordingly, as used herein, the “working membrane area” is defined as the area of the membrane through which chemical substance may diffuse.

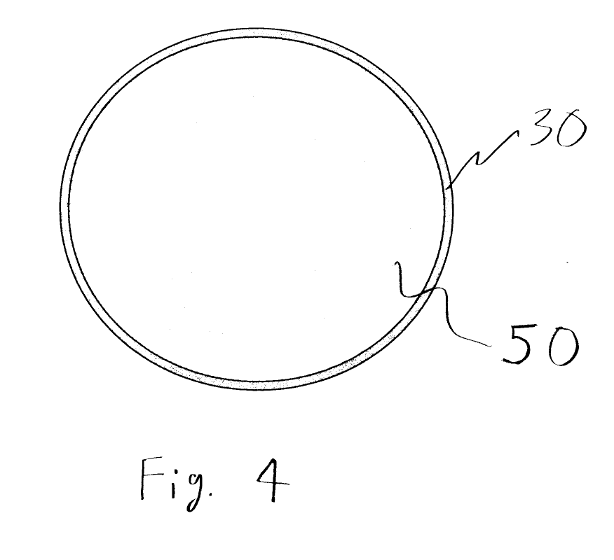

By way of example only and not by way of limitation, if a membrane area constituted 15 square centimeters, but 5 square centimeters of the membrane area was clamped between structure to hold the membrane in place, thus effectively preventing chemical substance from diffusing through the membrane 50 in these areas, the working membrane area of such a membrane would be about 10 square centimeters, assuming that the remaining 10 square centimeters was available for chemical substance diffusing. FIG. 4 depicts the membrane 50 spanning the cross-section of the conduit 30. The area of the membrane 50 shown inside the walls of the conduit 30 is the working membrane area.

According to yet another exemplary embodiment of the present invention, the volumetric gas flow rate through the conduit 30 amounts to, in some embodiments, less than about 50 cubic centimeters per minute per 3 cubic centimeters of swab cross-flow area. According to another exemplary embodiment of the present invention, volumetric gas flow rate through the conduit 30 amounts to less than about 30 cubic centimeters per minute per 3 cubic centimeters of swab cross-flow area. According to another exemplary embodiment of the present invention, volumetric gas flow rate through the conduit 30 amounts to less than about 20 cubic centimeters per minute per 3 cubic centimeters of swab cross-flow area. According to another exemplary embodiment of the present invention, volumetric gas flow rate through the conduit 30 amounts to less than about 10 cubic centimeters per minute per 3 cubic centimeters of swab cross-flow area. According to another exemplary embodiment of the present invention, volumetric gas flow rate through the conduit 30 amounts to less than about 8 cubic centimeters per minute per 3 cubic centimeters of swab cross-flow area. According to another exemplary embodiment of the present invention, volumetric gas flow rate through the conduit 30 amounts to less than about 6 cubic centimeters per minute per 3 cubic centimeters of swab cross-flow area. According to another exemplary embodiment of the present invention, volumetric gas flow rate through the conduit 30 amounts to less than about 4 cubic centimeters per minute per 3 cubic centimeters of swab cross-flow area. According to another exemplary embodiment of the present invention, volumetric gas flow rate through the conduit 30 amounts to 2 cubic centimeters per minute per 3 cubic centimeters of swab cross-flow area. According to another exemplary embodiment of the present invention, volumetric gas flow rate through the conduit 30 amounts to about 1-2 cubic centimeter per minute per 3 cubic centimeters of swab cross-flow area. According to another exemplary embodiment of the present invention, volumetric gas flow rate through the conduit 30 amounts to about 1-5 cubic centimeters per minute per 3 cubic centimeters of swab cross-flow area.

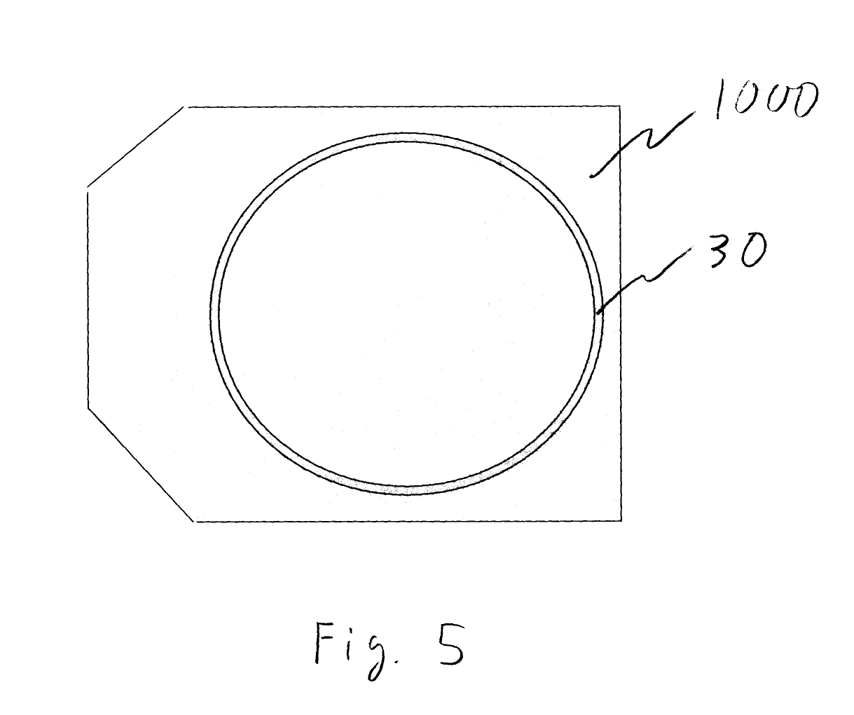

The phrase “swab cross-flow area” will now be explained. The swab cross-flow area is defined as the area of the swab that is subjected to a cross-flow of gas (i.e., flow of gas through the swab) that is captured by the conduit 30 for direction down the conduit towards the membrane 50. By way of example only, and not by way of limitation, if a swab has 4 square centimeters of porous area through which a gas is directed (in this example, the cross-sectional area of conduit 85 may be 4 square centimeters to obtain this through-flow area), but the conduit 30 has a cross-sectional area, at the end of the conduit, facing the swab, of only 3 square centimeters, and this cross-sectional area is “shadowed” (see FIG. 5, more on this below) by the 4 square centimeters of the swab, the swab cross-flow area is 3 square centimeters. FIG. 5 depicts a view, looking “down” the throat of conduit 30, of a swab 1000, inserted into the receptacle 20. The area inside the walls of conduit 30 correspond to the swab cross-flow area, as the area of flow through the swab 1000 that is captured by the conduit 30 is the area “shadowed” by the conduit (assuming that the conduit 85 in turn shadows the conduit 30).

In some embodiments of the present invention the analytical instrument 10 is configured such that the volumetric flow rate of gas entraining the chemical substance may be controlled and adjusted. By way of example only and not by way of limitation, the analytical instrument 10 may be configured to be “reprogrammed” to have a different flow rate. Alternatively or in addition to this, electromechanical structure of the analytical instrument 10 may be adjusted and/or replaced to achieve this flow rate. By way of example only and not by way of limitation, the pump 80 may be exchanged for another pump providing lower and/or higher volumetric flow rates, although in other embodiments, the pump may be configured to be adjusted by hand, etc.

In some embodiments of the present invention, the analytical instrument 10 corresponds to the SABRE 4000™ produced by Smiths Detection™, the performance characteristics, operational characteristics and/or the major components thereof being usable in the analytical instrument 10 according to an embodiment of the present invention, the pertinent volumetric flow rates, however, being different as detailed herein, the design and all of the just mentioned characteristics and components of the SABRE 4000™ being incorporated herein by reference in their entirety.

In some embodiments, the membrane 10 may comprise a sheet of silicone-based rubber material such as dimethyl silicone rubber.

Given the disclosure of the present invention, one versed in the art would appreciate that there are other embodiments and modifications within the scope and spirit of the present invention. Accordingly, all modifications attainable by one versed in the art from the present disclosure within the scope and spirit of the present invention are to be included as further embodiments of the present invention.

1. An analytical instrument, comprising:
a chemical substance analyzer, including:
a desorber;
a swab receptacle forming a chemical substance entrainment area proximate the desorber;
a conduit in fluid communication with the entrainment area; and
a membrane, wherein the membrane extends across a cross-section of the conduit, wherein the membrane is positioned to have a desorber side in gas communication with the desorber and an analysis side opposite the desorber side;
wherein the analytical instrument is adapted to supply a gas through the entrainment area to entrain in the gas at least a portion of a chemical substance located in the entrainment area and direct, at a first volumetric flow rate, the gas entraining the chemical substance through the conduit that guides the gas entraining the chemical from the entrainment area towards the membrane so that at least a portion of the entrained chemical substance is transferred to the membrane by interacting with the desorber side of the membrane,
wherein the membrane is adapted to diffuse at least a portion of the chemical substance transferred to the membrane through the membrane to the analysis side, and
wherein the first volumetric flow rate is less than about 50 cubic centimeters per minute per 3 cubic centimeters of cross-sectional conduit area.

2. The analytical instrument of claim 1, wherein the first volumetric flow rate is less than about 10 cubic centimeters per minute per 3 cubic centimeters of cross-sectional conduit area

3. The analytical instrument of claim 1, wherein the first volumetric flow rate is less than about 4 cubic centimeters per minute per 3 cubic centimeters of cross-sectional conduit area.

4. (canceled)

5. The analytical instrument of claim 1, wherein the first volumetric flow rate is about 1-5 cubic centimeters per minute per 3 cubic centimeters of cross-sectional conduit area.

6. The analytical instrument of claim 1, wherein the first volumetric flow rate is about 1-2 cubic centimeters per minute per 3 cubic centimeters of cross-sectional conduit area.

7. The analytical instrument of claim 1, wherein the substance analyzer includes an ion mobility spectrometer (IMS).

8-13. (canceled)

14. An analytical instrument, comprising:
a chemical substance analyzer, including:
a desorber; and
a membrane, wherein the membrane is positioned to have a desorber side in gas communication with the desorber and an analysis side opposite the desorber side;
wherein the analytical instrument is adapted to supply a gas through an entrainment area proximate to the desorber to entrain in the gas at least a portion of a chemical substance located in the entrainment area and direct the gas entraining the chemical substance, at a first volumetric flow rate, towards the membrane so that at least a portion of the entrained chemical substance is transferred to the membrane by interaction with the desorber side of the membrane,
wherein the membrane is adapted to diffuse at least a portion of the chemical substance transferred to the membrane through the membrane to the analysis side, and
wherein the first volumetric flow rate is less than about 50 cubic centimeters per minute per 3 cubic centimeters of working membrane area.

15. The analytical instrument of claim 14, wherein the first volumetric flow rate is less than about 10 cubic centimeters per minute per 3 cubic centimeters of working membrane area.

16. The analytical instrument of claim 14, wherein the first volumetric flow rate is less than about 4 cubic centimeters per minute per 3 cubic centimeters of working membrane area.

17. The analytical instrument of claim 14, wherein the first volumetric flow rate is about 1-5 cubic centimeters per minute per 3 cubic centimeters of working membrane area.

18. The analytical instrument of claim 14, wherein the first volumetric flow rate is about 1-2 cubic centimeters per minute per 3 cubic centimeters of working membrane area.

19. The analytical instrument of claim 14, wherein the substance analyzer includes an ion mobility spectrometer (IMS).

20. A method of analyzing a chemical, comprising:
obtaining chemical substance;
entraining at least a portion of the chemical substance in a gas flow and directing the entraining gas flow, at a first volumetric flow rate, towards a membrane;
transferring at least a portion of the entrained chemical substance onto the membrane;
diffusing at least a portion of the transferred chemical substance through the membrane; and
chemically analyzing at least a portion of the chemical substance diffused through the membrane, and
wherein the first flow rate is less than about 50 cubic centimeters per minute per 10 cubic centimeters of working membrane area.

21. The method of claim 20, wherein the first volumetric flow rate is less than about 10 cubic centimeters per minute per 3 cubic centimeters of working membrane area.

22. The method of claim 20, wherein the first volumetric flow rate is less than about 4 cubic centimeters per minute per 3 cubic centimeters of working membrane area.

23. The method of claim 20, wherein the first volumetric flow rate is about 1-5 cubic centimeters per minute per 3 cubic centimeters of working membrane area.

24. The method of claim 20, wherein the first volumetric flow rate is about 1-2 cubic centimeters per minute per 3 cubic centimeters of working membrane area.

25. The method of claim 20, wherein chemically analyzing at least a portion of the chemical substance diffused through the membrane includes performing ion mobility spectrometry on the analyzed portion to determine an identity of the analyzed portion.

26. An analytical instrument, comprising:
a chemical substance analyzer, including:
a swab receptacle forming a chemical substance entrainment area proximate the desorber; and
a membrane in fluid communication with the swab receptacle;
wherein the analytical instrument is adapted to supply a gas through the entrainment area to entrain in the gas at least a portion of a chemical substance located in the entrainment area and direct, at a first volumetric flow rate, the gas entraining the chemical substance towards the membrane to permit the entrained chemical substance to transfer to the membrane, wherein the first volumetric flow rate is less than about 50 cubic centimeters per minute.

27. The apparatus of claim 26, wherein the first volumetric flow rate is about 1-5 cubic centimeters per minute.

28. A method of analyzing a chemical, comprising:
obtaining a chemical substance;
entraining at least a portion of the chemical substance in a gas flow and then directing the entraining gas flow, at a first volumetric flow rate, towards a membrane so that at least a portion of the entrained chemical substance transfers to the membrane;
wherein the first flow rate is less than about 50 cubic centimeters per minute.

29. (canceled)

30. The analytical instrument of claim 1, wherein interaction of the chemical substance with the membrane increases the macroscopic sensitivity of the apparatus.
